(19) United States
(12) Patent Application Publication
(10) Pub. No.: US 2026/0084861 A1
(43) Pub. Date: Mar. 26, 2026

(54) CASING WITH DETACHMENT FLAP AND CONTAINER SURROUNDED BY SUCH A CASING

(71) Applicant: SLEEVER INTERNATIONAL COMPANY, MORANGIS (FR)

(72) Inventor: Eric FRESNEL, MORANGIS (FR)

(21) Appl. No.: 19/341,982

(22) Filed: Sep. 26, 2025

(30) Foreign Application Priority Data
Sep. 26, 2024 (FR) FR2410298

(51) Int. Cl. B65D 23/08; B65D 23/14

(52) U.S. Cl. CPC B65D 23/0878; B65D 23/14

(57) ABSTRACT

A casing, intended to surround at least one section of at least one container, includes at least one main strip of heat-shrinkable material having at least one preferred direction of shrinkage. The casing includes at least one complementary flap including a base attached to a main strip so as to be secured to the main strip at least at each of the longitudinal edges of the main strip, the main strip and the flap thus jointly forming a closed sleeve, and a grip tab extending the base without itself being secured to the main strip, at least said grip tab being made of a material different from that of the main strip.

The invention relates to a casing comprising a flap having a grip tab that is not secured to the rest of the casing.

The invention also relates to a container covered with such a security casing.

### BACKGROUND OF THE INVENTION

In certain fields, it is important to provide containers with devices which guarantee that they cannot be opened, in particular, to prevent counterfeiting in the form of illegal refilling.

In the field of wine and spirits bottles, it is thus common practice to over-mould the stopper by using a capsule that is pressed onto the bottle or that is crimped onto the bottle. However, counterfeiters hardly have any difficulty in replacing one initial capsule with another, such that the simple overcap capsule does not provide any sufficient protection.

Thus, in order to try to provide greater protection, it is also common practice to cover the neck of the stoppered container with a heat-shrinkable plastic sleeve. To open the container, it is necessary to remove the heat-shrunk sleeve, thereby destroying it.

Such a sleeve thus makes it possible to further secure the container associated.

In order for the consumer to be able to remove the sleeve without any difficulty, it is common practice to equip the heat-shrinkable sleeve with pre-cuts or micro-perforations defined by cut-out planes adapted according to uses: for example, two lines of perforations parallel to each other. The user may thus pull on the band, delimited by two perforation lines (called “tirecell”) to quickly and efficiently tear the entire sleeve.

However, the user then ends up, on one hand, with the sleeve and, on the other hand, with the tirecell, which must both be discarded. However, the tie-cell is very small, forming “micro-waste” that is difficult to recycle and may even easily be lost somewhere in the environment if the sleeve is torn outside.

This is obviously not desirable, from an environmental point of view.

### AIM OF THE INVENTION

The aim of the invention is to provide an innovative casing, in particular, for containers, that is more environmentally-friendly.

The invention also relates to a container covered by such a casing.

### SUMMARY OF THE INVENTION

To achieve this aim at least partially, a casing is proposed, intended to surround at least one section of at least one container, the casing comprising at least one main strip of heat-shrinkable material having at least one preferred direction of shrinkage.

According to the invention, the casing comprises at least one complementary flap comprising:
A base attached to the main strip so as to be secured to the main strip at least at each of the longitudinal edges of the main strip, the main strip and the flap thus jointly forming a closed sleeve;
A grip tab extending the base without itself being secured to the main strip, at least said grip tab being made of a material different from that of the main strip.

Thus, the container is used by pulling on the grip tab. The traction exerted on the strip will then tear it, for example, along a rupture line located near a junction area at the base of the flap on the main strip.

However, since the flap is not formed by the main strip itself but is attached to the main strip, the flap will remain integral with the strip despite the rupture of the strip.

The user therefore removes the casing in one piece from the container (the flap remaining attached to the main strip).

The risk of losing a part of the casing into the environment is therefore drastically reduced.

In addition, the casing thus generates more easily recoverable waste.

The invention therefore makes it possible to secure a container while being more environmentally-responsible than any existing solutions.

In the present application, a “material” refers to all of the materials forming the strip or the flap. The material may thus be formed from a single material or from several materials, each material itself being made from a composition that may comprise a single component or a plurality of components. Thus, when it is stated that the strip is made of a “heat-shrinkable material”, the strip may be formed by a single layer or by several layers, each layer then being able to be made by a different material from that of the other layers. Whether the strip comprises a single layer or several layers, at least one layer may be formed by a composition comprising a single component or several components. For example, each layer may be formed from a composition comprising a single type of polymer or comprising several types of polymers. Naturally, the same reasoning applies to the flap.

In terms of the present application, unless otherwise indicated, the temperatures and characteristics indicated are associated with atmospheric pressure.

Optionally, the flap as a whole is made of a material different from that of the main strip.

Optionally, at least the grip tab is made of a plastic material whose base polymer is identical to that of the plastic material of the strip.

Optionally, the strip and/or at least the grip tab is made of or based on a material that is at least partially bio-sourced.

Optionally, the strip and/or at least the grip tab is made of a material that is at least partially recycled.

Optionally, the strip and/or at least the grip tab is made of a compostable material.

Optionally, both of the longitudinal edges of the strip do not have an overlap area.

Optionally, the strip comprises at least one area of embrittlement.

Optionally, the flap and/or the strip comprises at least one print.

Optionally, the flap carries at least one electronic element.

The invention also relates to a container surrounded by a casing, as mentioned above.

Other features and advantages of the invention will become apparent on reading the following description of particular and non-limiting embodiments of the invention.

### BRIEF DESCRIPTION OF THE DRAWINGS

The invention will be best understood in the light of the description below, in reference to the accompanying figures, among which:

FIG. 1 is a diagrammatic perspective view of a security casing in a first embodiment of the invention;

FIG. 2 is a diagrammatic top view of the casing shown in FIG. 1;

FIG. 3 is a front view of an unfolded strip of the casing shown in FIG. 1;

FIG. 4 is a front view of an unfolded flap of the casing shown in FIG. 1;

FIG. 5 is a perspective view of a container covered by the casing shown in FIG. 1;

FIG. 6 is a diagrammatic top view of a casing according to a second embodiment of the invention;

FIG. 7 is a diagrammatic top view of a casing according to a third embodiment of the invention;

FIG. 8 is a diagrammatic top view of a casing according to a fourth embodiment of the invention.

FIG. 9 is a diagrammatic top view of a casing according to a second embodiment of the invention;

FIG. 10 is a side view of a sheath comprising several casings such as those shown in FIG. 1.

### DETAILED DESCRIPTION OF THE INVENTION

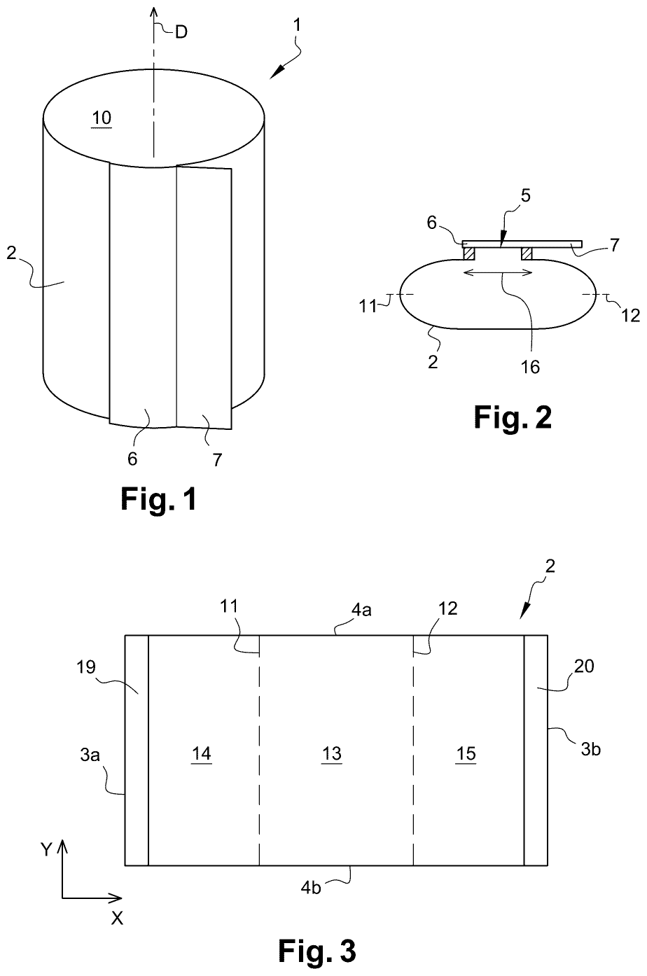

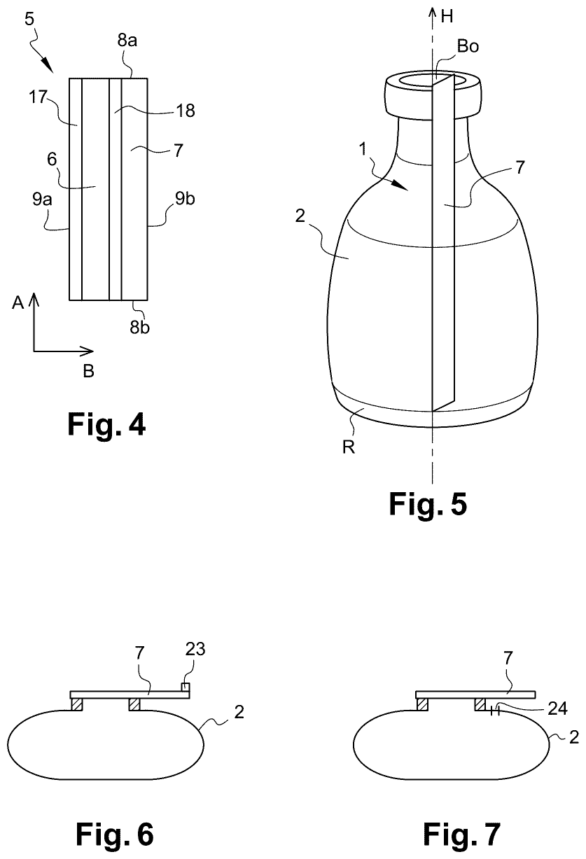

With reference to FIGS. 1 to 5, the casing 1 in the first embodiment of the invention comprises a main strip 2.

In the first embodiment, the strip 2 forms a flat rectangle extending longitudinally along a first axis X and laterally along a second axis Y, orthogonal to the first axis X. The strip 2 thus has two longitudinal ends 3a, 3b (on either side of the first axis X) and two lateral ends 4a, 4b (on either side of the second axis Y).

The strip 2 is heat-shrinkable.

In this case, the strip 2 is single-layered, said layer being made of a heat-shrinkable plastic material.

The strip 2 comes, for example, from a cut-out of some film made of said heat-shrinkable plastic material, the film has been stretched to give it a single preferred shrinkage direction or several preferred shrinkage directions. At least one preferred shrinkage direction is preferably in the X direction or in the Y direction.

The strip 2 is, for example, based on, or made of, polyester, such as polyethylene terephthalate (better known by the acronym PET) or polylactic acid (better known by the acronym PLA).

Whatever the material of the strip 2, it may be formed from a composition comprising at least a portion of recycled material. Per 100 parts of composition, the composition comprises between 0 and 100 parts by weight of recycled material and, for example, between 0 and 60 parts by weight of recycled material and, for example, between 0 and 50 parts by weight of recycled material and, for example, between 0 and 30 parts by weight of recycled material and, for example, between 0 and 20 parts by weight of recycled material. Said recycled material may be pre-consumer or post-consumer recycled material.

The strip 2 may thus be compostable depending on the material used.

Furthermore, the casing 1 comprises at least one complementary flap 5 associated with the strip 2, mentioned above.

For this purpose, the flap 5 comprises a base 6 extended by a grip tab 7. Preferably, the flap 5 is a single piece. The base 6 and the grip tab 7 are thus made in one piece. Preferably, there is thus no physical junction between the base 6 and the grip tab 7. The entire flap 5 is thus, in this case, in the same material.

In the first embodiment, the flap 5 forms a flat rectangle extending longitudinally along a first axis A and laterally along a second axis B, orthogonal to the first axis A. The flap 5 thus has two longitudinal ends 8a, 3b (on either side of the first axis A) and two lateral ends 9a, 4b (on either side of the second axis B).

The flap 5 is attached to the strip 2 so as to be secured to the strip 2. It will therefore be understood that the flap 5 and the strip 2 are not a single piece. Thus, the flap 5 and the strip 2 are not made of one single piece. There is indeed a physical junction between the flap 5 and the strip 2.

The flap 5 is also defined such that its height (considered along the first axis A) is, in this case, equal (plus or minus 2%) to the height (considered along the second axis Y) of the strip 2.

The flap 5 is attached to the strip 2 such that its first axis A extends parallel to the second axis Y of the strip 2 and/or such that its second axis B extends parallel to the first axis X of the strip 2.

The flap 5 is optionally taller than it is wide when it is in place on the strip 2.

The flap 5 is also attached such that the strip 2 and the flap 5 together form a closed sleeve 10. This closed sleeve 10 thus extends longitudinally along an axial direction D which is, in this case, parallel to the first axis A and to the second axis Y.

Before it is put into place onto a container R, the sleeve 10 is packaged flat: it therefore has two folds 11, 12 allowing it to flatten. Preferably, these folds 11, 12 extend parallel to each other. Preferably, these folds 11, 12 extend parallel to the axial direction D and/or to the first axis A and/or to the second axis Y.

Preferably, both of the folds 11, 12 are formed at the strip 2. The flap 5 is thus not folded.

Preferably, the strip 2 is folded so as to have a central flank 13 extended on a first side by a first panel 14 (the first fold 11 separating the central flank 13 from the first panel 14) and on a second side by a second panel 15 (the second fold 12 separating the central flank 13 from the second panel 15). The central flank 13 is thus enclosed on either side by the panels 14, 15. It will therefore be understood that the panels 14, 15 extend on either side of the central flank 13 along the first axis X. Preferably, the folds 11, 12 are such that the length (along the first axis X) of the central flank 13 is equal (to within plus or minus 2%) to the cumulative sum of the two lengths (along the first axis X) of the two panels 14, 15. Preferably, both of the panels 14, 15 are identical. In particular, the length of the panels (along the first axis X) is, in this case, identical. The strip 2 optionally is folded symmetrically. The strip 2 optionally is symmetrical.

In the case of the first embodiment, the strip 2 is folded so as to remain open. A spacing 16 is thus present between both of its longitudinal ends 3a, 3b.

This spacing 16 has, for example, a length (along the first axis X) in the range [0; 5 millimetres] and preferably in the range [0; 4 millimetres] and preferably in the range [0; 3 millimetres].

In contrast, the flap 5 is arranged on the strip 2 so as to cover this spacing 16. Thus, the flap 5 and the strip 2 form the sleeve 10 that is well closed to it. Of course, the flap 5 covers the spacing via the outside of the strip 2 (as opposed to the inside of the strip 2 intended to rest against the container R).

In the present case, it is the base 6 that closes this spacing 16. The base 6 is thus secured to both of the panels 14, 15.

For example, the base 6 has a first junction panel 17 and a second junction panel 18. Preferably, both of these junction panels 17, 18 extend parallel to one another. These junction panels 17, 18, in this case, outline rectangles on the base 6. It will be understood that these junction panels 17, 18 are in one piece with the rest of the base 6 and are defined, in this case, only to clarify the connection of the base 6 to the strip 2.

Preferably, these two junction panels 17, 18 extend over the entire height (along the first axis A) of the base 6. Preferably, a first junction panel 17 forms a first lateral edge of the base 6 and preferably a second junction panel 18 forms a second lateral edge of the base 6. The two panels 17, 18 thus form the edges (along the second axis B) of the base 6. The width of at least one of the junction panels 17, 18 (along the second axis B) is, for example, between 1 and 5 millimetres and is, for example, between 2 and 3 millimetres. Preferably, both of the junction panels 17, 18 are identical to each other.

In corresponding manner, the strip 2 comprises a first junction panel 19 and a second junction panel 20. Preferably, both of these junction panels 19, 20 extend parallel to one another. Preferably, both of these junction panels 19, 20 extend parallel to one another. These junction panels 19, 20, in this case, outline rectangles on the base 6. It will be understood that these junction panels 19, 20 are in one piece with the rest of the strip 2 and are defined, in this case, only to clarify the connection of the base 6 to the strip 2.

Preferably, these two junction panels 19, 20 extend over the entire height (along the first axis A) of the strip 2. Preferably, a first junction panel 19 forms a first longitudinal edge of the base 2 and preferably a second junction panel 20 forms a second longitudinal edge of the base 2. both of the panels 19, 20 thus form the edges (along the first axis X) of the strip 2. It is therefore understood that it is these two edges which enclose the spacing 16 and are facing each other when the strip 2 is folded. The width of at least one of the junction panels 19, 20 (along the first axis X) is, for example, between 1 and 5 millimetres and, for example, between 2 and 3 millimetres. Preferably, both of the junction panels 19, 20 are identical to each other.

The base 6 is secured to the strip 2 at their respective junction panels, a respective one of the junction panels 17, 18 of the base 6 resting on a respective other of the junction panels 19, 20 of the strip 2. It must be noted that the base 6 is secured to the strip 2 on its outside.

The base 6 is preferably sealed to the strip 2. For this purpose, the base 6 is, for example, chemically bonded (for example, by solvent adhesive) and/or thermally bonded (by local heating, for example, according to the generic principle of assembly without any addition of material by intermolecular diffusion) to the strip 2.

On the other hand, the grip tab 7 is left free and is thus not secured to the strip 2. The flap 5 being arranged outside of the strip 2, the grip tab 7 therefore remains accessible by a user even if the casing 1 is in place on the container R. In particular, the grip tab 7 projects from the rest of the casing 1 since it is not sealed to the strip 2. The grip tab 7 thus forms a free edge of the flap 5.

Preferably, the grip tab 7 has the same height as the base 6 (along the first axis A).

In another aspect, at least the grip tab 7, and preferably, in this case, the entire flap 5, is made of a material different from that of the strip 2.

It must be noted a heat-shrinkable product (such as strip 2, in this present case) will undergo deformation when it is exposed to a temperature higher than its glass transition temperature. In particular, the product will retract (negative deformation) in its stretching direction(s) and will extend (positive deformation) in a direction normal to its stretching direction(s). For example, if the strip 2 is exposed to a temperature that is 10 degrees Celsius higher than its glass transition temperature, its negative deformation will be higher than 5%.

In the present example, the flap 5 must not undergo the same deformations as the strip 2 when it is retracted.

Thus, the material of flap 5 must be chosen appropriately.

For example, the flap 5 is not made of a heat-shrinkable material or is made of a heat-shrinkable material whose glass transition temperature is higher than that of the strip 2 and preferably much higher than that of the strip 2. The term ‘“considerably”’ means that the glass transition temperature of layer 5 is at least 60 degrees Celsius higher than that of layer 2 and, for example, at least 100 degrees Celsius higher.

For example, the flap 5 is made of a material such that the flap 5 is thermostable at the glass transition temperature of the strip 2 and/or at the temperature at which the strip 2 will be heated to ensure that it is shrunk onto the container and/or at a temperature range around the glass transition temperature Tg of the strip 2 (for example, such an interval is defined by [Tg−40 degrees Celsius; Tg+80 degrees Celsius], and, for example, defined by [Tg−20 degrees Celsius; Tg+60 degrees Celsius]). The flap 5 may thus be both thermally stable when the strip 2 is shrunk while also having (or not having) heat-shrinkable properties.

It must be noted a thermostable product will not undergo deformation when it is exposed to a temperature lower than its melting point. In particular, the product will not undergo deformation regardless of the direction of the space in question (plus or minus 5%) for a temperature below its melting point.

In the present example, the flap 5 is chosen so as to be thermostable at the glass transition temperature of the strip 2 or to be thermostable at a given temperature range around this glass transition temperature. For example, if the flap 5 is exposed to a temperature that is higher by 10 degrees Celsius than the glass transition temperature of the strip 2, the deformation of the flap will be less than 5% regardless of the direction of the space.

For example, in order to fulfil this thermostability condition mentioned above, the flap 5 is:
in a crystalline material, and, for example, in a crystalline thermoplastic material, and/or
in a material not stretched in at least one preferred direction and, for example, in a thermoplastic material not stretched in at least one preferred direction, and/or
in a material that has undergone at least one heat treatment (such as annealing) and, for example, in a thermoplastic material that has undergone at least one heat treatment (such as annealing),
etc.

Preferably, the material of the flap 5 is chosen such that the flap 5 softens at the glass transition temperature of the strip 2 or at the given temperature range around this glass transition temperature. For this purpose, said material is, for example, chosen so as to have a melting temperature and/or glass transition temperature higher than the glass transition temperature of the strip 2. The melting and/or glass transition temperature of the flap 5 is, for example, less than 100 degrees higher than the glass transition temperature of the strip 2.

Thus, the combination of this softening with the retraction force of the strip 2 on the flap 5 (due to the retraction of the strip 2) will allow the base 5 to deform slightly (while remaining within the limits of the above-mentioned 5% to maintain its thermostability). The base 5 may thus adopt the shape of the container R to some extent. However, it will be understood that without the retraction force mentioned above, the base 5 would not undergo any deformation.

Optionally, the flap 5 is made of a material of the same nature as the strip 2, i.e., the flap 5 is made of a plastic whose base polymer is identical to that of the plastic of the strip 2. On the other hand, unlike that of the strip 2, the plastic material of the flap 5 is in a transformation state called thermostable at the glass transition temperature of the strip 2 and/or at an interval defined around said glass transition temperature. As a result, the flap 5 is made of a different material from that of the strip 2 (actually, at least one characteristic of the material of the flap 5 and the strip 2 is different).

It is thus possible advantageously to construct the flap 5 and the strip 2 from the same plastic film, the film however being stretched in a second step to be able to form the strip 2 while the film making it possible to form the flap 5 is not stretched and/or while the film making it possible to form the flap 5 undergoes at least one additional heat treatment (with respect to the film from which the strip 2 is formed).

This promotes synergy between the base 6 and the strip 2.

This also makes the casing 1 easier to recycle.

The flap 5 is, for example, based on, or made of, polyester, such as polyethylene terephthalate (better known by the acronym PET) or polylactic acid (better known by the acronym PLA).

Whatever the material of the flap 5, it may be formed from a composition comprising at least a portion of recycled material. Per 100 parts of composition, the composition comprises between 0 and 100 parts by weight of recycled material and, for example, between 0 and 50 parts by weight of recycled material and, for example, between 0 and 30 parts by weight of recycled material and, for example, between 0 and 20 parts by weight of recycled material. Said recycled material may be pre-consumer or post-consumer recycled material.

The flap 5 may thus be compostable depending on the material used.

The casing 1 thus described may then be arranged around the container R in order to surround a section of said container R at 360°.

For example, the casing 1 may surround the container R so as to extend from a lower part of the container R to an upper part of the container R and, for example, to the stopper Bo of the container R. The casing 1 may extend so as to at least partially cover an upper surface of the stopper Bo.

In this position, the axes X and A extend in the axial direction H of the container R (that is vertical when the container R rests on a horizontal base) and the axes Y and B extend in a circumferential direction of the container R.

The casing 1 is then secured to the container 3 by heat shrinkage.

Under such circumstances, the casing 1 protects the container 3 from any fraudulent opening. In this case, the casing 1 is a security casing.

Furthermore, when the user wishes to open container R, it is sufficient to pull on the grip tab 7 (projecting from the rest of casing 1) to cause the rest of the casing 1 to tear, that will remain in one piece, with the grip tab 7 remaining attached to the strip 2 via the base 6 of the flap 5. Indeed, advantageously, the strip 2 tears naturally upstream from the spacing 16 (according to a direction of traction of the grip tab 7). The strip 2 thus tears naturally in an area located under the grip tab 7 when no force is exerted on it.

With reference to FIG. 10, a sheath 21 may be made from a first film made from the material of the strip 2 and a second film made from the material of the flap 5, the second film being sealed to the first film to close the sheath 21. The sheath 21 may then be pre-cut transversely such that each sheath section 21 delimited by two successive pre-cut lines 22 forms the casing 1 that has just been described.

The sheath 21 may then be wound into a coil.

This coil may then be used in the packaging plant such that it may be arranged on a whole series of containers.

With reference to FIG. 6, there follows a description of a second embodiment.

In this second embodiment, the grip tab 7 is equipped on its external surface (opposite to that facing the strip 2) with one or more gripping elements 23 such as ribs, roughened areas, reinforcements, etc. This makes it easier for the user to manipulate the grip tab 7.

Apart from this characteristic, everything that has been said for the first embodiment is also applicable for the second embodiment.

With reference to FIG. 7, there follows a description of a third embodiment.

In this third embodiment, the strip 2 comprises an area of embrittlement 24. This will make it possible to tear the strip 2 at this area of embrittlement 24.

For example, the area of embrittlement 24 is formed by pre-cuts and/or micro-drills. For example, the pre-cuts/perforations may be made at regular intervals over the entire area of embrittlement 24.

The width of the area of embrittlement 24 (along the first axis X) is, for example, between 0.2 mm and 2 mm and, for example, between 0.8 mm and 1.2 mm.

Preferably, the area of embrittlement 24 forms a line.

For example, the area of embrittlement 24 extends parallel to the second axis Y of the strip.

For example, the area of embrittlement 24 extends over the entire height (along the second axis Y) of the strip.

Preferably, said area of embrittlement 24 extends in the strip 2 on one of the panels 14, 15. For example, the area of embrittlement 24 extends to one of the edges of the junction panels 19, 20 of the strip 2 while remaining outside the junction panel in question 19, 20. The area of embrittlement 24 is, for example, arranged at the edge [of the junction panel (i.e., 19, 20)] furthest from the longitudinal end (respectively 3a, 3b) associated with said panel (respectively 19, 20).

The area of embrittlement 24 is thus arranged upstream of the junction panels between the strip 2 and the flap 5 (in a direction in which the grip tab 7 is pulled). The area of embrittlement 24 is thus arranged under the tab 7 when no force is exerted on the tab 7.

Apart from this area of embrittlement 24, everything that has been said in terms of the first embodiment and the second embodiment, the same is also applicable to the third embodiment.

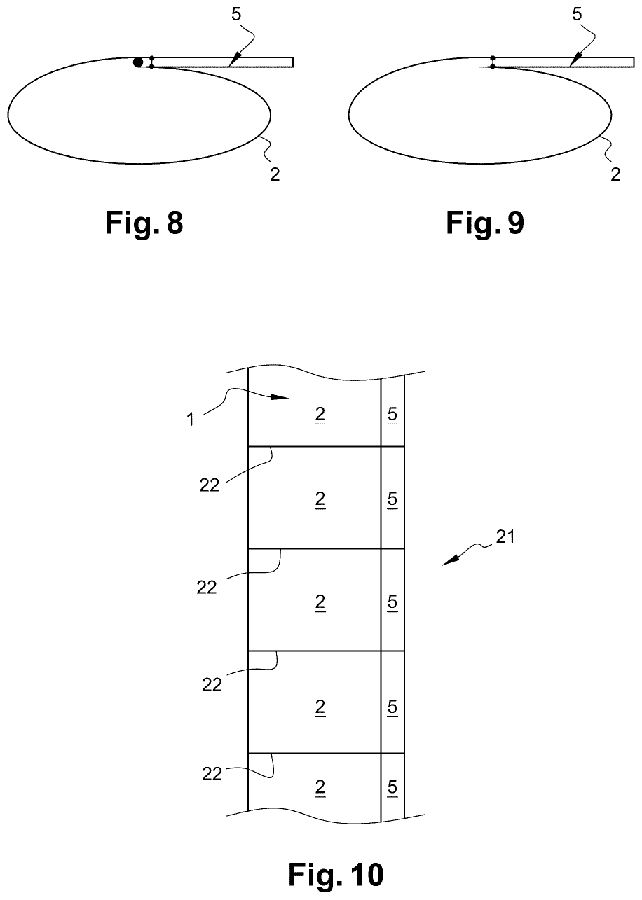

With reference to FIG. 8, there follows a description of a fourth embodiment.

In this fourth embodiment, unlike the first embodiment, the strip 2 is folded so as to be directly closed.

More precisely, one of the longitudinal ends extends under the longitudinal edge associated with the other of its longitudinal ends (whereas in the first embodiment, the two longitudinal ends of the strip 2 were at the same level).

This longitudinal end is then sealed to the facing portion of the strip 2, and more precisely, in this case, to the facing longitudinal edge.

The flap 5 is then inserted between the two panels 14, 15 of the strip 2 (part of one of the longitudinal edges of the strip 2 actually projecting beyond the rest of the strip 2, outside of it). The base 5 is then sealed, on the one hand, at its internal surface, on the external surface of the strip 2, and, on the other hand, at its external surface, on the internal surface of the strip 2. The base 5 is thus secured via its internal surface to one of the longitudinal edges of the strip 2 and via its external surface to the other of the longitudinal edges of the strip 2.

It will be understood that, in the case of the first embodiment, the base 5 has been sealed to the strip 2 in two areas of its internal surface, whereas, in this case, the base 5 is sealed to the strip 2 in one area of its external surface and in one area of its internal surface. Preferably, both of these areas are then aligned (according to the thickness of the base 2).

Apart from these characteristics, everything that has been said in terms of the first embodiment, second embodiment and third embodiment, the same is also applicable to this fourth embodiment.

With reference to FIG. 9, there follows a description of a fifth embodiment.

In this fifth embodiment, unlike the first embodiment, the strip 2 is folded so as to have an overlap area at its longitudinal edges.

This is also the case in the fourth embodiment. However, unlike the fourth embodiment, the two longitudinal edges are not directly fixed to each other.

The flap 5 is then inserted between the two panels 14, 15 of the strip 2 (part of one of the longitudinal edges of the strip 2 actually projecting beyond the rest of the strip 2, externally). The base 5 is then sealed, on the one hand, at its internal surface, on the external surface of the strip 2, and, on the other hand, at its external surface, on the internal surface of the strip 2. The base 5 is thus secured via its internal surface to one of the longitudinal edges of the strip 2 and via its external surface to the other of the longitudinal edges of the strip 2.

It will be understood that, in the case of the first embodiment, the base 5 has been sealed to the strip 2 in two areas of its internal surface, whereas, in this case, the base 5 is sealed to the strip 2 in one area of its external surface and in one area of its internal surface. Preferably, both of these areas are then aligned (according to the thickness of the base 2).

It will be understood that, in the case of the fourth embodiment, the strip 2 was also sealed on itself (in a junction area downstream of those of the base 5 to the strip 2), whereas, in this case, the strip 2 is closed only by means of the base 5. There are therefore two junction areas in the fifth embodiment compared to three for the fourth embodiment.

Apart from these characteristics, everything that has been said in terms of the first embodiment, second embodiment, third embodiment and fourth embodiment, the same is also applicable to this fifth embodiment.

The invention is not limited to the embodiments described, but on the contrary, includes any variant having, with equivalent means, the main features stated above.

The strip may equally well be transparent or opaque. The strip may be transparent in some areas and opaque in others. The strip may comprise prints on at least a part of its surface and on one or both surfaces. Information for the user may thus be written on the strip.

Likewise, the flap may be opaque or transparent. The flap may be transparent in some areas and opaque in others. The flap may comprise prints on at least a portion of its surface and on one or both of its surfaces. Information for the user may thus be entered on the panel.

The flap, and, in particular, the grip tab, may comprise one or more electronic components. The grip tab may thus comprise one or more electronic components printed directly on the grip tab, such as an antenna and, for example, an RFID antenna.

Printing on the strip and/or band may also be used to help align the band with the strip when forming the casing.

It is also possible to provide junction panels of a height less than that of the strip and/or of the flap.

The area of embrittlement may be different from that described and, for example, may extend over only part of the height of the strip.

The sleeve may be equipped on its internal surface (i.e., the surface intended to come into contact with the container to be covered) with a safety strip. In this case, the safety strip may extend substantially over the entire circumference of the sleeve. Said safety strip may be shaped so as to come to bear under the ring of a container.

The materials indicated for the strip and for the flap may be different. For example, the strip and/or the flap may be made of a material that is at least partially bio-sourced. For example, the material may be formed at least in part by a bio-based plastic, such as PLA, a PLA derivative or any other bio-based plastic. For the purposes of this application, it must be noted that a “bio-based” product is manufactured using materials derived from living organisms, specifically plants (wood, hemp, beetroot, corn, etc.), or animal-based materials (wool, organic waste, etc.).

Although, in this case, the flap is made of the same type of material as the strip, the flap may be made of a different type of material. For example, the flap may be made of a different polymer than that used for the material of the strip; or it may be made of an amorphous material; or it may be made of a non-plastic material such as paper or cardboard, etc.

Preferably, the material of the flap will be chosen such that it may be compostable.

Preferably, the material of the strip will be chosen such that it such be compostable.

Although, in this case, the casing surrounds only one container at any one time, the casing may be shaped to surround two or more containers at any one time.

Although, in this case, the casing is in the form of a cylinder open at both ends, the casing may take another shape, for example, a frustoconical shape. The casing may thus be shaped into a cap, a stopper, a capsule, etc. The casing may comprise at least one notch on its upper part (for example, to facilitate deposition on the top of the container and, for example, on its stopper).

The container to which the casing will be attached may be of any type: glass, plastic, etc.

Although, in this case, the strip is single-layered, the strip may be multi-layered, with at least one of its layers being made of a plastic material as described in the case of the single-layered material.

Likewise, although, in this case, the flap is single-layered, it may be multi-layered at least at its base and/or grip tab. In this case, at least one of its layers may be made of a material as described in the case of the single-layered material. For example, a flap may have a central layer made of plastic or non-plastic material (cardboard, paper, etc.), with the central layer covered on both main surfaces by two surfaces made of a different material, such as plastic.

1. A casing intended to surround at least one section of at least one container, the casing comprising at least one main strip of heat-shrinkable material having at least one preferred direction of shrinkage, wherein the casing comprises at least one complementary flap comprising:
a base attached to the main strip so as to be secured to the main strip at least at each of the longitudinal edges of the main strip, the main strip and the flap thus jointly forming a closed sleeve;
a grip tab extending the base without itself being secured to the main strip, at least said grip tab being made of a material different from that of the main strip.

2. The casing according to claim 1, wherein the flap as a whole is made of a material different from that of the main strip.

3. The casing according to claim 1, wherein at least the grip tab is made of a plastics material whose base polymer is identical to that of the plastics material of the strip.

4. The casing according to claim 1, wherein the strip and/or at least the grip tab is made of or based on a material that is at least partially bio-based.

5. The casing according to claim 1, wherein the strip and/or at least the grip tab is made of a material that is at least partially recycled.

6. The casing according to claim 1, wherein the strip and/or at least the grip tab is made of a compostable material.

7. The casing according to claim 1, wherein both of the longitudinal edges of the strip do not have an overlap area.

8. The casing according to claim 1, wherein the strip comprises at least one area of embrittlement.

9. The casing according to claim 1, wherein the flap and/or the strip comprises at least one print.

10. The casing according to claim 1, wherein the flap carries at least one electronic element.

11. A container surrounded by a casing according to claim 1.
